(19) United States
(12) Patent Application Publication
(10) Pub. No.: US 2023/0386726 A1
(43) Pub. Date: Nov. 30, 2023

(54) INDUCTIVE COMPONENT HAVING JOINED CORE PARTS

(71) Applicant: Robert Bosch GmbH, Stuttgart (DE)

(72) Inventors: Matthias Stein, Königslutter am Elm (DE); Roland Scheuerer, Stuttgart (DE)

(21) Appl. No.: 18/251,110

(22) PCT Filed: Oct. 14, 2021
(86) PCT No.: PCT/EP2021/078494

§ 371 Date: Apr. 28, 2023

(30) Foreign Application Priority Data
Oct. 29, 2020 (DE) 10 2020 213 628.9

(51) Int. Cl. H01F 27/22; H01F 27/26; H01F 27/28

(52) U.S. Cl. CPC H01F 27/22; H01F 27/263; H01F 27/2804; H01F 2027/2819

(57) ABSTRACT

The invention relates to an inductive component. The component comprises a coil core, in particular a ferrite core, and at least one coil winding. The coil core is formed by at least two core parts, or only two core parts, in particular one core part and one additional core part. The core parts form the coil core when assembled. The core parts have respective joining surfaces which are designed to face each other when the core parts are joined. According to the invention, in the inductive component of the aforementioned type, at least one of the core parts has a through-opening. The through-opening is arranged and designed to lead heat-conducting medium into a cavity, in particular a gap, extending between the joining surfaces and to fill said cavity with the heat-conducting medium.

### BACKGROUND

The invention relates to an inductive component. The component comprises a coil core, in particular a ferrite core, and at least one coil winding. The coil core is formed by at least two core parts, or only two core parts, in particular one core part and one additional core part. The core parts form the coil core when assembled. The core parts have respective joining surfaces which are designed to face each other when the core parts are joined.

A transformer with an I-shaped core and two O-shaped cores, which can be assembled, is known from DE 11 2006 002 062 T5.

### SUMMARY

According to the invention, in the inductive component of the aforementioned type, at least one of the core parts has a through-opening. The through-opening is arranged and designed to lead heat-conducting medium into a cavity, in particular a gap, extending between the joining surfaces and to fill said cavity with the heat-conducting medium.

Advantageously, heat-conducting medium can be introduced into the cavity, in particular into the gap between the joining surfaces of the core parts that abut each other. The heat-conducting medium can thus advantageously be introduced into the gap extending between impact points of the core parts upon the incremental joining of a coil core as well as in the case of coil cores already assembled from core parts.

In a preferred embodiment, the coil core is configured so as to conduct and/or amplify a magnetic field. Preferably, the core parts are respectively configured so as to conduct a magnetic field on a contact surface formed by the joining surfaces. In this manner, a magnetic flux can advantageously flow through the core parts, and thus a closed magnetic circle can be formed.

In a preferred embodiment, at least one core part has a recess on the joining surface. The recess is configured so as to lead a flowable heat-conducting medium. Preferably, the through-opening adjoins the recess and is arranged and configured so as to supply the heat-conducting medium to the recess. The recess is preferably configured so as to distribute the heat-conducting medium in the cavity, in particular the gap, extending between the joining surfaces. Advantageously, a distribution system can thus be formed by means of the recess, which facilitates an even filling of the gap with the heat-conducting medium.

In a preferred embodiment, the core part with the through-opening is formed flat on a side which faces the cavity, in particular the gap. The core part with the through-opening preferably has at least one recess configured so as to supply heat-conducting medium to the through-opening. Advantageously, when the core part is placed with the through-opening onto a heat-conducting medium pad, which has been dispensed onto a standing surface, for example, the heat-conducting medium in the recess flows towards the through-opening and penetrates the core part with the through-opening, and thus flows into the gap towards the other core part.

For example, the core part with the through-opening can be heat-conductingly connected to a radiator, in particular a heat sink. To this end, the core part with the through-opening can be placed together with the further core part on the heat sink. At the contact point of the coil core with the heat sink, heat-conducting medium, in particular thermal paste or thermal adhesive, can have previously been dispensed. When placing the coil core thus formed, the heat-conducting medium can then flow along the recesses in the core part with the through-opening towards the through-opening, penetrate the through-opening, and flow further into the gap extending between the core parts. The joining surfaces of the core parts are thus heat-conductingly bridged or coupled to each other via the heat-conducting medium. Waste heat generated in the further core part can thus be conducted to the heat sink via a thermal conduction path comprising the joining surfaces, the heat-conducting medium, and the core parts.

In a preferred embodiment, the recess or recesses comprise at least a trench or a groove. Preferably, the trench or groove is configured so as to distribute the heat-conducting medium in the cavity, in particular the gap. The trench or groove in the core part with the through-opening is preferably configured so as to supply the heat-conducting medium to the through-opening. Advantageously, a distribution system can be formed in this manner, which is configured so as to convey a direction of flow of the heat-conducting medium upon the placement of the coil core onto the heat-conducting medium dispensed on the heat sink to the locations that can be closed by the heat-conducting medium.

In a preferred embodiment, the recess has trenches facing away from the through-opening in a radial or star-shaped manner. In this manner, the heat-conducting medium can be supplied in a star-shaped manner to the through-opening. In the case of the recess formed in the region of the gap, the heat-conducting medium can advantageously be distributed so as to drift apart from one another radially from the through-opening. The star-shaped recesses in the region of the gap and on the side of the core part facing away from the gap can be formed together or independently on a coil core.

In a preferred embodiment, the core part having the through-opening is configured as a flat plate, in particular. Further preferably, the core part having the through-opening is configured as a rectangular or rod-shaped plate. The coil core can this be advantageously flat.

In a preferred embodiment, the further core part, in particular the core part without the through-opening, is at least partially U-shaped. The further core part preferably has U-legs. Preferably, a joining surface, in particular an end face, is respectively configured on each U-leg for laminar contacting of the core part with the through-opening. Advantageously, such a transformer can be realized in a space-saving manner. For example, the U-shaped further core part can be wrapped on each leg by a coil winding. Advantageously, such a transformer can be formed in a space-saving manner.

In a preferred embodiment, the further core part is E-shaped. The further core part has three legs, which face in the same direction in particular, each having a joining surface for laminar assembly, in particular magnetic contacting of the core part with the through-opening. Advantageously, the e-core can thus be formed by simply placing it on the core part with the through-opening, hereinafter also referred to as the I-core. In the recesses extending between the legs, a respective coil winding can be arranged. For magnetic contact, one of the three middle legs can be spaced apart from the I-core so that only the outer legs rest on the I-core. Preferably, a gap in the region of the middle leg is 20 to 200 micrometers, preferably between 50 and 150 micrometers. Preferably, a gap height in the region of the middle leg is formed greater than a gap height of the gaps on the outer legs. Advantageously, a transformer having the E-core part configured in this way can produce soft switching operations.

The invention also relates to a component, in particular to a transformer or a transducer, in particular having the core parts according to the aforementioned type. Preferably, the component has two electrical coils, each of which are twisted about the core part, in particular the further core part. The core parts are preferably configured so as to transfer a magnetic flux generated by one of the coils towards the other coil. Advantageously, a magnetic circle can thus be formed with the joined core parts.

The invention also relates to a contact assembly comprising a heat sink and at least one component of the aforementioned type. Preferably, a recess or depression is configured in the heat sink for receiving a core part with the through-opening. Advantageously, heat-conducting medium can flow from the depression through the through-opening into the cavity, in particular into the gap. The core part with the through-opening, or the coil core composed of the core parts, can be placed on a heat-conducting medium introduced in the depression. The heat-conducting medium can be a component of the contact assembly.

In a preferred embodiment, the through-opening is formed on at least one outer edge of the core part. In this manner, the heat-conducting medium can flow in the through-hole up to the gap, bounded by a sidewall of the depression in the heat sink, and fill it with the heat-conducting medium.

In a preferred embodiment, the heat-conducting medium comprises a matrix material and further preferably filling particles. Preferably, the filling particles comprise ceramic particles and/or magnetic, in particular ferromagnetic or magnetizable particles, in particular ferrite particles, for example manganese-zinc ferrite or nickel-zinc ferrite. By means of the ceramic filling particles, a thermal conductivity of the heat-conducting medium can be advantageously improved. By means of the ferromagnetic particles, a magnetic flux flowing through the gap can advantageously be improved.

The invention also relates to a method for cooling a transformer core. In the method, in a first step, a transformer core comprising two core parts is placed on a heat sink. Heat-conducting medium applied to the heat sink, in particular heat-conducting medium paste, flows through a through-opening of the core part contacting the heat sink into a gap, in particular a bridge gap, extending between the core parts. The heat-conducting medium connects the core parts there to each other in a heat-conducting manner or additionally in a magnetically conductive manner.

Advantageously, steps of a multiple application of heat-conducting medium can thus be saved.

The cooling assembly can comprise the heat-conducting paste with the magnetic or magnetically alignable particles independent from or in addition to the breakthrough and/or recess in the core part. Advantageously, an inductive component with a core assembled from core parts can thus have an improved magnetic conductivity.

The heat-conducting medium can be a heat-conducting paste, in particular a particulate-filled paste, preferably a silicone paste, or a heat-conducting adhesive, for example silicone-based or epoxy-based, or acrylate-based. Preferably, the heat-conducting medium has an oil, or fat, in particular a silicone oil and/or silicone fat as the matrix material, and heat-conducting filling particles, in particular ceramic particles. For example, the ceramic particles include aluminum particles, carbide particles, or nitride particles.

Preferably, the filling particles comprise ferrite particles. The heat-conducting medium can be non-cross-linking or cross-linking, in particular self-cross-linking.

Preferably, the heat-conducting medium has a viscosity such that the heat-conducting medium can flow in the channels, in the through-hole, or in the gaps upon insertion or assembly of the core parts, in particular the E-core and/or the I-core.

Preferably, the heat-conducting medium has a thixotropic property. Advantageously, the heat-conducting medium can become thinner as a result of pressurization or movement and can become tougher again after resting.

### BRIEF DESCRIPTION OF THE DRAWINGS

The invention will now be described in the following with reference to figures and embodiment examples. Further advantageous design variants will emerge from a combination of the features described in the figures and in the dependent claims.

FIG. 1 shows an embodiment example of a contact assembly in which a component, in particular a transformer, is heat-conductingly connected to a magnetically conductive coil core composed of core parts and having a heat sink, wherein a heat-conducting medium from a reservoir in the heat sink can flow into gaps extending between the core parts as well as into a gap between the coil core and the heat sink;

FIG. 2 shows the contact assembly shown in FIG. 1 in an aerial view.

### DETAILED DESCRIPTION

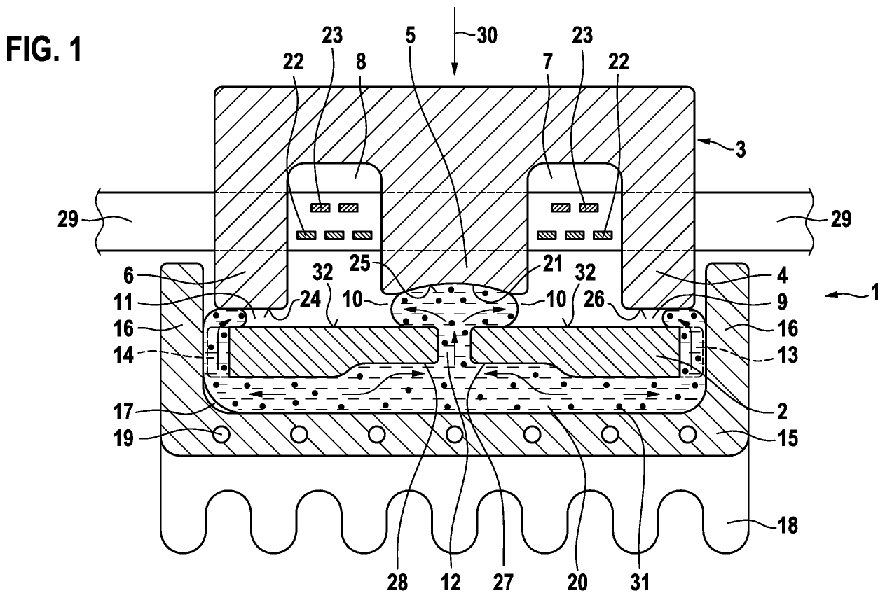

FIG. 1 shows schematically an embodiment example for a contact assembly 1. The contact assembly 1 has an inductive component. The inductive component forms a transformer in this embodiment example. The transformer has a transformer core comprising an I-shaped core part 2 and an E-shaped core part 3. The core parts 2 and 3 are configured so as to be assembled, and when assembled form a magnetic circle.

The E-shaped core part 3, hereinafter also referred to as the E-core, has three legs, namely a leg 4 and a leg 6, which respectively form an outer leg. The e-core 3 also has a middle leg 5, which extends between the outer legs 4 and 6. The legs 4, 5 and 6 each have a joining surface, in particular an end face, which is configured so as to be placed on the core part 2 with its flat extension and to contact the core part 2 magnetically conductively in order to form a magnetic circular flux. In this embodiment example, the I-shaped core part 2 is configured as a flatly extending body, in particular a plate.

Recesses are formed between the three legs of the e-core, so that the legs of the e-core are spaced apart from each other. A recess 7 is formed between the leg 4 and the leg 5, and a recess 8 is formed between the legs 5 and 6. The recesses 7 and 8 are respectively configured so as to receive a longitudinal portion of at least one coil winding, such that the coil winding is guided through the recess.

During operation of the transformer, waste heat is generated in the core part 3. The waste heat can be conducted via the legs 4, 5, and 6 to the core part 2. The legs 4 and 6 in each case lie with their respective joining surfaces 26 or 24, in particular with a small gap dimension, on the core part 2, and there on its joining surface 32 formed by a surface. A gap-like cavity 9 extends between the joining surface 26 of the leg 4 and the core part 2, in particular the joining surface 32. Between the joining surface 24 of the leg 6 and the core part 2, a gap-like cavity 11 extends. The waste heat generated in the core part 3 can be transferred by conduction of heat when the joining surfaces of the e-core lie on the i-core, in particular as in the case of heat transfer from bodies lying flatly one on top of the other. The heat transfer from the core part 3 towards the core part 2 can be improved in this embodiment example by introducing heat-conducting medium 20 into the gaps 9 and 11, respectively.

The core part 2 has a breakthrough 12, previously also known as a through-opening, for this purpose. In this embodiment example, the breakthrough 12 is arranged in the region of the leg 5. The middle leg 5 is, in particular for electromagnetic reasons, more spaced apart from the core part 2 with its joining surface 25 than the joining surfaces 24 and 26 of the outer legs 4 and 6. The gap 10 thus formed between the joining surface 25 of the middle leg 5 and the core part 2 is thus formed larger than the gap 9 and 11 extending between the outer legs 4 and 6 and the core part 2.

In this embodiment example, the core part 2 is configured so as to thermally conductively contact a heat sink 15 with a flat side opposite the core part 3. The heat sink 15 has a depression 17, which is configured so as to receive the core part 2 and at least a part of the core part 3. The heat sink 15 has a web 16 configured circumferentially around the depression 17. The web 16 thus forms a type of wall of a tray in which the core part 2, and in this embodiment example a part of the core part 3, are accommodated. In this embodiment example, the contact assembly 1 also comprises the heat-conducting medium 20. In this embodiment example, the heat-conducting medium 20 has been applied to a bottom of the depression 17, and thus has been applied, in particular dispensed, to the heat sink 15. The core part 3 can be pressed onto the core part 2 for heat-conducting connection to the core part 2, as indicated by an arrow 30. In a further embodiment, a contact pressure can act directly on the core part 2.

The core part 2 lying in the depression 17 is thereby pressed onto the heat-conducting paste pad or heat-conducting medium supply located at the bottom of the depression 17. The heat-conducting medium 20, in particular a heat-conducting medium paste, can spread between the core part 2 and the heat sink 15. In this embodiment example, groove-shaped recesses are formed in the core part 2, which point towards the through-opening 12. Of the groove-shaped recesses, a groove-shaped recess 27 and a groove-shaped recess 28 are shown.

The heat-conducting medium can be passed into the depression 17 upon pressing the core part 2 through the through-opening 12 and thus into the gap 10 extending between the middle leg 5 and the core part 2. The gap 10 can thus be filled in by the heat-conducting medium 20. In this embodiment example, an in particular groove-shaped or tapered recess 21 is formed on the joining surface 25 of the middle leg 5, which facilitates a lateral distribution of the heat-conducting medium 20 in the gap 10.

In this embodiment example, the core part 2 has a through-opening 13 and a through-opening 14 in the region of the outer legs 4 and 6. The through-openings 13 and 14 are each configured as trenches that run transversely to the flat extension of the core part. The heat-conducting medium 20 can flow into the gaps 9 and 11 extending between the outer legs 4 and 6, respectively, in the through openings 13 and 14, bounded by the core part 2 and the wall 16 of the heat sink 15. The in particular gap-like cavities extending between the core part 3 and the core part 2 can thus be filled with only one heat-conducting medium supply introduced into the depression 17 of the heat sink 15 with the heat-conducting medium 20.

In this embodiment example, the heat-conducting medium 20 has magnetic field-enhancing, in particular ferromagnetic particles 31. For example, the particles 31 are ferrite particles.

The contact assembly 1 also comprises a circuit carrier 29. The circuit carrier 29 is configured as a multilayer circuit carrier. In this embodiment example, the circuit carrier 29 has two electrically conductive coils 22 and 23, each forming a coil of the transformer. The coils 22 and 23 are respectively formed by parts of electrically conductive layers of the circuit carrier 29, which are connected transversely to a flat extension of the circuit carrier 29 by means of electrically conductive via-connections. In this manner, flat coils extending in the flat extension of the circuit carrier 29 can be configured in the circuit carrier, which can respectively pass through one of the recesses 7 or 8, which extend between the legs of the e-core 3.

In addition to or independently of the groove-shaped recesses 27 and 28 formed in the core part 2, the heat sink 15 can have groove-shaped recesses at the bottom of the depression 17, which are configured so as to direct heat-conducting medium 20 towards the through-opening 12 in the core part 2.

For example, the heat sink 15 can comprise the fluid channels 19 shown in FIG. 1 for guiding a cooling fluid and/or cooling ribs 18 for convectively dissipating waste heat.

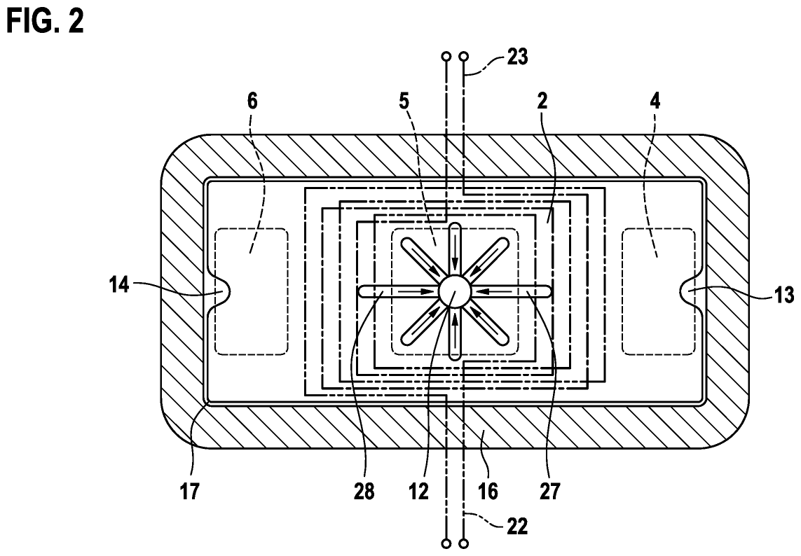

FIG. 2 shows the contact assembly 1 already shown in FIG. 1 in an aerial view. The wall 16 surrounding the depression 17 encloses the flat-shaped core part 2 in which the through-opening 12 is formed. In the core part 2, recesses, in this embodiment example grooves, are formed on the side facing the heat sink 15 radially towards the through-opening 12. Of the grooves, the grooves 27 and 28 are denoted by way of example. The heat-conducting medium 20 can flow towards the through-opening 12 upon pushing the core part 2 onto the bottom of the depression 17 in the grooves 27 and 28.

The outer legs 4 and 6, and the middle leg 5, each of which attach with their joining surface to the core part 2 with the through-opening 12, are marked with a dash. In the core part 2, the groove-shaped through-openings 13 and 14 are configured, each of which are configured so as to supply the heat-conducting medium 20 into the gap extending between the outer legs 4 and 6 and the core part 2. In this example, the through-holes 13 and 14 terminate against the wall 16, which connects to the core part 2, in particular with a small gap dimension, for example between 100 micrometers and 1000 micrometers, to a circumferential boundary of the core part 2.

The heat-conducting medium 20 can thus preferably flow in the groove-shaped through-openings 13 and 14 towards the core part 3, in particular the outer legs 4 and 6.

In addition to or independently of the recesses 13 and 14 on the core part 2, recesses can be configured for leading heat-conducting medium, in particular heat-conducting medium paste, in the wall 16 of the heat sink 15.

In this embodiment, the core part 2 seals with the wall 16 of the heat sink such that the heat-conducting medium flows predominantly or only through the recesses 13 and 14 when the core part 2 is pressed into the depression 17.

The core part 2 has a greater width dimension and/or longitudinal dimension than the core part 3 in the embodiment example shown in FIG. 1. In a further embodiment, the I-shaped core part 2 can have the same surface dimension as the E-shaped core part 3.

The transformer coils 22 and 23 surround one of the outer legs 4 and 6 circumferentially with the coil windings of the coils, respectively. In this embodiment example, the coil 23 has two coil windings. In this embodiment example, the coil 22 has three coil windings. With the coil 22 as the primary coil, the transformer can thus convert a voltage applied to the primary coil 22 downwards. A voltage applied to the coil 23 can be converted upwards to the coil 22.

The groove-shaped recesses, of which the recesses 27 and 28 are denoted by way of example, can be formed in the core part 2 on its side facing the heat sink 15 and/or in the bottom of the heat sink 15.

1. An inductive component (2, 3, 22, 23) comprising a coil core (2, 3) and at least one coil winding (22, 23), wherein the coil core (2, 3) is formed by at least two core parts (2, 3) which form the coil core (2, 3) when assembled, and the core parts (2, 3) have respective joining surfaces (24, 25, 26, 32) which are configured to face each other when the core parts (2, 3) are joined,
wherein
at least one of the core parts (2, 3) has a through-opening (12), which is arranged and configured to lead a heat-conducting medium (20) into a cavity (9, 10, 11) extending between the joining surfaces (2, 24, 25, 26) and to fill said cavity with the heat-conducting medium (20).

2. The component (2, 3) according to claim 1,
wherein
at least one core part (2, 3) has a first recess (21), which is configured to lead a flowable heat-conducting medium (20) and connects the through-opening (12) to a second recess (27, 28) and is arranged and configured to supply the heat-conducting medium (20) to the first recess (21), and the first recess (21) is configured to distribute the heat-conducting medium (20) in the cavity (9, 10, 11) extending between the joining surfaces (24, 25, 26, 32).

3. The component (2, 3) according to claim 1,
wherein
on a side facing away from the cavity (9, 10, 11) the core part (2) with the through-opening (12) has at least one recess (27, 28) configured to supply heat-conducting medium (20) to the through-opening (12).

4. The component (2, 3) according to claim 2,
wherein
the first and/or second recess (21, 27, 28) has at least one trench or groove.

5. The component according to claim 2,
wherein
the first and/or second recess (21, 27, 28) has trenches facing away from the through-opening (12) in a radial or star-shaped manner.

6. The component (2, 3) according to claim 1,
wherein
the core part (2) with the through-opening (12) is configured as a flat plate.

7. The component (2, 3) according to claim 1,
wherein
one of the core parts (3) is at least partially U-shaped, and joining surfaces (24, 25, 26) are configured on U-legs (4, 5, 6) for laminar joining of the core part (2) with the through-opening (12).

8. The component according to claim 1,
wherein
one of the core parts (3) is E-shaped and has three legs (4, 5, 6), which respectively face in a same direction and which comprise a respective joining surface (24, 25, 26) for laminar joining of the core part (2) with the through-opening (12).

9. The component (2, 3, 22, 23) according to claim 1,
wherein
the component (2, 3) has two electrical coils (22, 23), which are respectively wound around one of the core parts (3).

10. A contact assembly (1) comprising a heat sink having a component according to claim 1,
wherein
a depression (17) is configured in the heat sink (15) for receiving the core part (2) with the through-opening (12) so that heat-conducting medium (20) can flow from the depression (17) through the through-opening (12) into the cavity (24, 25, 26).

11. The contact assembly according to claim 10,
wherein
the contact assembly (1) comprises the heat-conducting medium (20) and the heat-conducting medium (20) comprises a matrix material and ferromagnetic filling particles (31).

12. A method for cooling a transformer core,
wherein a transformer core (2, 3) comprising two core parts (2, 3) is placed on a heat sink (15), and heat-conducting medium (20) applied to the heat sink (15) flows through a through-opening (12) of the core part (2) contacting the heat sink (15) into a gap (9, 10, 11) extending between the core parts (2, 3) and the core parts (2, 3) are heat-conductively or additionally magnetically conductively connected to one another there.

13. The component (2, 3) according to claim 1, wherein the coil core (2, 3) is a ferrite core.

14. The component (2, 3) according to claim 9, wherein the component (2, 3, 22, 23) is a transformer or a transducer.

15. The method according to claim 12, wherein the heat conducting medium (20) is a thermal paste.
